(19) United States
(12) Patent Application Publication
(10) Pub. No.: US 2012/0082896 A1
(43) Pub. Date: Apr. 5, 2012

(54) NONAQUEOUS ELECTROLYTE SECONDARY BATTERY

(75) Inventors: Yasufumi Takahashi, Kobe-city (JP); Masahisa Fujimoto, Osaka-city (JP)

(73) Assignee: SANYO ELECTRIC CO., LTD., Osaka (JP)

(21) Appl. No.: 13/250,408

(22) Filed: Sep. 30, 2011

(30) Foreign Application Priority Data
Sep. 30, 2010 (JP) 2010-221677

(51) Int. Cl. H01M 4/42; H01M 4/583

(52) U.S. Cl. 429/220; 429/229

(57) ABSTRACT

A nonaqueous electrolyte secondary battery includes a positive electrode containing a positive electrode active material, a negative electrode containing a negative electrode active material, and a nonaqueous electrolyte. A mixture containing a zinc-containing alloy represented by MZnₓ (wherein M is at least one metal that is not electrochemically alloyed with lithium) and a carbon material is used as the negative electrode active material.

### CROSS REFERENCE TO RELATED APPLICATIONS

The present application claims priority to Japanese Patent Application No. 2010-221677 filed in the Japan Patent Office on Sep. 30, 2010, the entire contents of which are incorporated herein by reference.

### BACKGROUND OF THE INVENTION

1. Field of the Invention

The present invention relates to a nonaqueous electrolyte secondary battery using an improved negative electrode active material for a negative electrode.

2. Description of Related Art

In recent years, nonaqueous electrolyte secondary batteries in which charge and discharge are performed by moving lithium ions between a positive electrode and a negative electrode have been used as power supplies for mobile electronic devices.

Also, in recent years, reduction in size and weight of mobile devices such as mobile phones, notebook-size personal computers, PDA, etc. has significantly advanced, and power consumption has been increased with the realization of multifunction. In addition, nonaqueous electrolyte secondary batteries used as power supplies of these devices have been increasingly demanded to have a high capacity and high energy density.

In the nonaqueous electrolyte secondary batteries, lithium cobaltate LiCoO₂, spinel lithium manganate LiMn₂O₄, a lithium-cobalt-nickel-manganese composite oxide, a lithium-aluminum-nickel-manganese composite oxide, and a lithium-aluminum-nickel-cobalt composite oxide are known as positive electrode active materials for positive electrodes. In addition, metallic lithium, carbon such as graphite, and materials which are alloyed with lithium, such as silicon and tin as described in Journal of Electrochemical Society 150 (2003) A679 (Non-Patent Document 1), are known as negative electrode active materials for negative electrodes.

When metallic lithium is used as a negative electrode active material, it is difficult to handle and needle-shaped dendrite composed of metallic lithium occurs by charge and discharge, thereby causing internal short-circuit between the negative electrode and a positive electrode. Therefore, there are problems with battery life, safety, etc.

When a carbon material is used as a negative electrode active material, dendrite does not occur. In particular, use of graphite among carbon materials has the advantages of excellent chemical durability and structural stability, a high capacity per unit mass, high reversibility of lithium occlusion/release reaction, a low action potential, and excellent flatness. Therefore, graphite is often used for power supplies of mobile devices.

However, graphite has the problem that the theoretical capacity of intercalation complex LiC₆ is 372 mAh/g, and thus it is impossible to sufficiently comply with the above-described demand for a high capacity and high energy density.

In order to produce a nonaqueous electrolyte secondary battery having a high capacity and high energy density using graphite, a negative electrode mixture containing graphite having a scaly primary particle shape is strongly compressed and bonded to a current collector to increase the packing density of the negative electrode mixture, thereby increasing the volume specific capacity of the nonaqueous electrolyte secondary battery.

However, in this case, when the packing density is increased by compressing the negative electrode mixture containing graphite, the graphite having a scaly primary particle shape is excessively oriented during compression, thereby causing the problems of decreasing the ionic diffusion rate in the negative electrode mixture to decrease the discharge capacity and increasing the action potential during discharge to decrease the energy density.

In addition, Si, Sn, or an alloy containing such an element has recently been proposed as a negative electrode active material having a high capacity density and high energy density in terms of mass ratio. Such a material exhibits a high capacity by unit mass of 4198 mAh/g in terms of Si and 993 mAh/g in terms of Sn. However, the material has the problem that the action potential at the time of discharge is higher than that of a graphite negative electrode, and volumetric expansion/contraction occurs during charge and discharge, resulting in deterioration in cycling characteristics.

Tin, silicon, magnesium, aluminum, calcium, zinc, cadmium, and silver are known as elements that are alloyed with lithium.

Japanese Published Unexamined Patent Application No. 2004-213927 (Patent Document 1) discloses the use of a negative electrode material containing a carbonaceous material, a graphite material, and metal nano fine particles having an average particle diameter of 10 nm or more and 200 nm or less and composed of a metal element selected from Ag, Zn, Al, Ga, In, Si, Ge, Sn, and Pb.

Patent Document 1 also discloses that by using the metal nano fine particles having a very small average particle diameter from the beginning, the influence of reduction in size of the particles due to expansion/contraction accompanying charge and discharge is suppressed, thereby improving cycling characteristics.

However, there is the problem that the nano metal fine particles having a small average particle diameter are difficult to produce, and charge and discharge cannot be properly performed with metal nano fine particles composed of a metal element, such as Si, which has a different action potential from that of graphite during discharge. Also, even the fine particles cannot be suppressed from being further reduced in size, and thus an electrode is expanded to degrade the current collecting property, thereby causing the problem of degrading the cycling characteristics.

### BRIEF SUMMARY OF THE INVENTION

An object of the present invention is to provide a nonaqueous electrolyte secondary battery having a high capacity, a high energy density, and excellent charge/discharge cycling characteristics.

The present invention provides a nonaqueous electrolyte secondary battery including a positive electrode containing a positive electrode active material, a negative electrode containing a negative electrode active material, and a nonaqueous electrolyte, a mixture containing a zinc-containing alloy represented by MZnₓ (wherein M is at least one metal that is not electrochemically alloyed with lithium) and a carbon material being used as the negative electrode active material.

According to the present invention, it is possible to produce a nonaqueous electrolyte secondary battery having a high capacity, a high energy density, and excellent charge/discharge cycling characteristics.

The metal M in MZnₓ is preferably at least one selected from Ti, Cu, and Nb, and more preferably Ti.

In addition, x in MZnₓ is preferably a value satisfying 2≦x≦15, and more preferably a value satisfying 10≦x≦15.

In the present invention, the content of the zinc-containing alloy in the negative electrode active material is preferably in the range of 5% to 80% by mss, and more preferably in the range of 30% to 70% by mass.

In the present invention, graphite is particularly preferably used as the carbon material.

According to the present invention, it is possible to produce a nonaqueous electrolyte secondary battery having a high capacity, a high energy density, and excellent charge/discharge cycling characteristics.

### BRIEF DESCRIPTION OF THE SEVERAL VIEWS OF THE DRAWINGS

FIG. 1 is a schematic sectional view showing a test cell formed in an example according to the present invention.

### DETAILED DESCRIPTION OF THE INVENTION

The present invention is described in further detail below.

### [Negative Electrode]

### <Zinc-Containing Alloy>

A zinc-containing alloy used in the present invention is an alloy represented by MZnₓ (wherein M is at least one metal that is not electrochemically alloyed with lithium).

When zinc is used as a negative electrode active material, weight lightening of a lithium ion battery is adversely affected because of the high specific gravity of zinc. However, the capacity density per unit volume is 2920 mAh/cm³ and is thus higher than that (837 mAh/cm³) of graphite mainly used at present.

Zinc assumes the same hexagonal closest-packed structure as hydrogen storing alloys which are currently used for nickel hydrogen batteries, and thus exhibits a high capacity. In addition, zinc causes smaller expansion/contraction than silicon and tin during charge and discharge. In alloying to obtain ZnLi from Zn, the rate of volumetric expansion of the Li alloy calculated from a crystal lattice constant is 1.98. On the other hand, in alloying to obtain Si₅Li₂₂ from silicon Si, the rate of volumetric expansion is 4.832, and in alloying to obtain Sn₄Li₂₂ from tin Sn, the rate of volumetric expansion is 3.779.

In the present invention, in order to further decrease the rate of volumetric expansion, the zinc-containing alloy represented by MZnₓ (wherein M is at least one metal that is not electrochemically alloyed with lithium) is used as the negative electrode active material.

Further, in the present invention, a mixture containing the zinc-containing alloy and a carbon material is used as the negative electrode active material. The effect of use of the mixture containing the zinc-containing alloy and the carbon material is described in the term <Mixing of zinc-containing alloy and carbon material>.

The metal element M in MZnₓ is a metal which is not electrochemically alloyed with lithium at room temperature (25° C.) and is preferably at least one selected from Ti, Cu, and Nb. The metal M is particularly preferably Ti. Therefore, MZnₓ is particularly preferably TiZnₓ.

In addition, x in MZnₓ is preferably a value satisfying 2≦x≦15, and more preferably a value satisfying 10≦x≦15. When the x value is excessively small, the zinc content in the zinc-containing alloy is decreased, and thus a high capacity cannot be obtained. While when the x value is excessively large, the zinc content in the zinc-containing alloy is increased, and thus the volumetric expansion/contraction of zinc-containing alloy particles during charge and discharge is increased. Therefore, charge/discharge cycling characteristics may be degraded.

The average particle diameter of the zinc-containing alloy particles is preferably in the range of 0.5 μm to 100 μm and more preferably in the range of 1 μm to 70 μm. When the average particle diameter of the zinc-containing alloy particles is excessively small, the specific surface area is increased. As a result, the particles may be easily oxidized in air, thereby failing to achieve sufficient battery characteristics due to inactivation of the metal. On the other hand, when the average particle diameter is excessively large, the alloy particles sediment when a negative electrode mixture slurry is formed, and thus the alloy particles are not uniformly dispersed in a negative electrode mixture. As a result, the effect of mixing of the alloy particles with the carbon material may not be sufficiently obtained.

The zinc-containing alloy particles are preferably formed by mixing zinc particles and particles of the metal M and then burning the resultant mixture in an inert gas atmosphere of argon. Burning in the inert gas atmosphere can suppress the production of impurities such as zinc oxide and titanium oxide. Therefore, a capacity loss and reduction in particle size due to expansion/contraction during charge and discharge can be suppressed, thereby improving the cycling characteristics.

In addition, grinding is preferably performed after burning. The grinding is preferably performed with a ball mill or the like.

### <Carbon Material>

Examples of the carbon material used in the present invention include graphite, petroleum coke, coal-derived coke, carbides of petroleum pitch, carbides of coal-derived pitch, phenol resins, carbides of crystalline cellulose resins and carbon produced by partial carbonization of the carbides, furnace black, acetylene black, pitch-based carbon fibers, PAN-based carbon fibers, and the like. From the viewpoint of conductivity and capacity density, graphite is preferably used.

The graphite preferably has a crystal lattice constant of 0.337 nm or less and as high crystallinity as possible because the conductivity and capacity density are high, and the action potential is decreased, thereby increasing the action voltage as a battery.

When the carbon material has a large particle diameter, contact with the metal is decreased, and conductivity on the negative electrode is decreased. On the other hand, when the particle diameter is excessively small, the specific surface is increased to increase the number of inactive sites, thereby decreasing the charge/discharge efficiency. Therefore, in the present invention, the average particle diameter of the carbon material is preferably in the range of 0.1 μm to 50 μm and more preferably in the range of 1 μm to 30 μm.

### <Mixing of Zinc-Containing Alloy Particles and Carbon Material>

The content of the zinc-containing alloy particles in the negative electrode active material is preferably in the range of 5 to 80% by mass, and more preferably in the range of 30 to 70% by mass.

When only the zinc-containing alloy particles and the carbon material are used as the negative electrode active material, the content of the carbon material in the negative electrode active material is preferably in the range of 20 to 95% by mass, and more preferably in the range of 30 to 70% by mass.

In the use of the mixture of the zinc-containing alloy particles and the carbon material as the negative electrode active material, even when the packing density of the negative electrode is increased, partial spaces are formed between the alloy particles and the carbon material, thereby improving nonaqueous electrolyte permeability. That is, when the mixture of the alloy particles and the carbon material is used, lithium alloys with zinc contained in the alloy particles to cause a proper degree of expansion and contraction during initial charge, and thus cracks, i.e., electrolytic solution paths, can be formed in the negative electrode. Therefore, the nonaqueous electrolyte permeability is improved. As a result, a nonaqueous electrolyte secondary battery having a high capacity, a high energy density, and excellent charge/discharge cycling properties can be produced.

When the content of the alloy particles is excessively small, the effect of mixing with the alloy particles may not be sufficiently obtained. When the content of the alloy particles is excessively large, excessive growth of cracks or breakage of the negative electrode structure may occur.

In order to uniformly disperse the alloy particles in the negative electrode mixture, preferably, the alloy particles and the carbon material are mechanically mixed using a stirring device or a kneading device such as a mortar, a ball mill, a mechanofusion, or a jet mill.

### <Formation of Negative Electrode>

In the present invention, the negative electrode can be formed by preparing the negative electrode mixture slurry containing the negative electrode active material and a binder, applying the negative electrode mixture slurry to a current collector including a copper foil, drying the slurry, and then rolling with a rolling roller. Since zinc contained in the alloy particles is easily eluted with water because of its high ionization tendency, an aprotic solvent such as N-methyl-2-pyrrolidone is preferably used as a solvent for forming the negative electrode mixture slurry.

The packing density of the negative electrode is preferably 1.7 g/cm³ or more, more preferably 1.9 g/cm³ or more, and still more preferably 2.0 g/cm³ or more. By increasing the packing density of the negative electrode, the negative electrode having a high capacity and high energy density can be formed. According to the present invention, even when the packing density of the negative electrode is increased, good charge/discharge cycling characteristics can be achieved.

The upper limit of the packing density of the negative electrode is not particularly limited, but is preferably 3.0 g/cm³ or less.

For example, polyvinylidene fluoride, polytetrafluoroethylene, EPDM, SBR, NBR, fluorocarbon rubber, and an imide resin can be used as the binder.

### [Positive Electrode]

As a positive electrode active material used for a positive electrode of the present invention, active materials generally used for nonaqueous electrolyte secondary batteries can be used. Examples thereof include lithium-cobalt composite oxides (for example, LiCoO₂), lithium-nickel composite oxides (for example, LiNiO₂), lithium-manganese composite oxides (for example, LiMn₂O₄ and LiMnO₂), lithium-nickel-cobalt composite oxides (for example, LiNi₁₋ₓCOₓO₂), lithium-manganese-cobalt composite oxides (for example, LiMn₁₋ₓCoₓO₂), lithium-nickel-cobalt-manganese composite oxides (for example, LiNiₓCO_{y}MnₓO₂ (x+y+z=1)), lithium-nickel-cobalt-aluminum composite oxides (for example, LiNiₓCO_{y}Al_{z}O₂ (x+y+z=1)), lithium transition metal oxides, manganese dioxide (for example, MnO₂), polyphosphorus oxides such as LiFePO₄ and LiMPO₄ (M is a metal element), metal oxides such as vanadium oxide (for example, V₂O₅), and other oxides, sulfides, and the like.

In order to increase the capacity density of the battery by combining the positive electrode with the negative electrode, it is preferred to use, as the positive electrode active material of the positive electrode, a lithium-cobalt composite oxide containing cobalt with a high action potential, for example, lithium cobaltate LiCoO₂, a lithium-nickel-cobalt composite oxide, a lithium-nickel-cobalt-manganese composite oxide, a lithium-manganese-cobalt composite oxide, or a mixture thereof. In order to produce the battery having a high capacity, a lithium-nickel-cobalt composite oxide or a lithium-nickel-cobalt-manganese composite oxide is more preferably used.

The material for a positive electrode current collector on the positive electrode is not particularly limited as long as it is a conductive material. For example, aluminum, stainless, and titanium can be used. In addition, for example, acetylene black, graphite, and carbon black can be used as the conductive material, and for example, polyvinylidene fluoride, polytetrafluoroethylene, EPDM, SBR, NBR, and fluorocarbon rubber can be used as the binder.

### [Nonaqueous Electrolyte]

As the nonaqueous electrolyte used in the present invention, nonaqueous electrolytes generally used for nonaqueous electrolyte secondary batteries can be used. For example, a nonaqueous electrolytic solution containing a solute dissolved in a nonaqueous solvent and a gel polymer electrolyte produced by impregnating a polymer electrolyte, such as polyethylene oxide or polyacrylonitrile, with the nonaqueous electrolytic solution can be used.

As the nonaqueous solvent, nonaqueous solvents generally used for nonaqueous electrolyte secondary batteries can be used. For example, cyclic carbonate and chain carbonate can be used. Examples of the cyclic carbonate which can be used include ethylene carbonate, propylene carbonate, butylene carbonate, vinylene carbonate, and fluorine derivatives thereof. Preferably, ethylene carbonate or fluoroethylene carbonate is used. Examples which can be used as the chain carbonate include dimethyl carbonate, methylethyl carbonate, diethyl carbonate, and fluorine derivatives thereof. Also, a mixed solvent prepared by mixing two or more nonaqueous solvents can be used. A mixed solvent containing cyclic carbonate and chain carbonate is preferably used. In particular, when the negative electrode including the negative electrode mixture with a packing density increased as described above is used, a mixed solvent containing cyclic carbonate at a mixing ratio of 35% by volume or less is preferably used for increasing permeability to the negative electrode. Further, a mixed solvent containing the cyclic carbonate and an ether solvent, such as 1,2-dimethoxyethane or 1,2-diethoxyethane, can be preferably used.

Also, as the solute, solutes generally used for nonaqueous electrolyte secondary batteries can be used. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, Li₂B₁₂Cl₁₂, and the like can be used alone or in combination of two or more.

As described above, according to the present invention, the zinc-containing alloy which is an alloy of zinc with metal M which is not alloyed with lithium is used, and thus the volumetric expansion/contraction by lithium occlusion/release during charge and discharge can be decreased. Therefore, the charge/discharge cycling characteristics can be improved as compared with the use of zinc metal particles.

In addition, since the mixture of the zinc-containing alloy and the carbon material is used, even when the packing density of the negative electrode is increased, partial spaces are formed between the alloy particles and the carbon material, thereby improving nonaqueous electrolyte permeability. As a result, a nonaqueous electrolyte secondary battery having a high capacity, a high energy density, high-rate charge/discharge characteristics, and excellent charge/discharge cycling characteristics can be produced.

### EXAMPLES

The present invention is described below with reference to examples, but the present invention is not limited to these examples and can be carried out with appropriate modifications without changing the gist of the invention.

### Example 1

### Formation of Zinc-Containing Alloy Particles

Zinc particles (manufactured by Kishida Chemical Co., Ltd., special grade, part No. 000-87575) having an average particle diameter of 4.5 μm and titanium particles (manufactured by Kojundo Chemical Lab Co., Ltd., 3N, part No. #TIE07PB) having an average particle diameter of 30 μm were mixed in an alumina crucible so as to produce the composition TiZn₁₅. The resultant mixture was burned at 420° C. for 5 hours in an argon (Ar) atmosphere. The resultant particle lumps were ground with a ball mill. Grinding with the ball mill was performed by repeating 40 times the operation of grinding at 250 rpm for 3 minutes using a SUS ball of 8.5 g and 12.5 mm in diameter and then stopping for 30 seconds.

Zinc alloy particles having an average particle diameter of 62 μm were formed as described above.

### [Formation of Negative Electrode]

The zinc alloy particles formed as described above were used as a first active material, and artificial graphite having an average particle diameter of 25 μm and a crystal lattice constant of 0.3362 nm was used as a second active material. The average particle diameters of the artificial graphite and the zinc alloy particles were measured using a laser diffraction particle size distribution analyzer (SALAD-2000 manufactured by Shimadzu Corporation). The first active material and the second active material were mixed at a mass ratio of 50:50 using a mortar. Next, the mixture of the first active material and the second active material was mixed with polyvinylidene fluoride as a binder and N-methyl-2-pyrrolidone as a dispersion medium so that the mass ratio (negative electrode active material: binder) of the negative electrode active material to the binder was 90:10, and the resultant mixture was kneaded to prepare a negative electrode mixture slurry.

The resultant negative electrode mixture slurry was applied to a negative electrode current collector including a copper foil, dried at 80° C., and then rolled with a rolling roller. Then, a current collector tab was attached to form a negative electrode.

### [Formation of Test Cell]

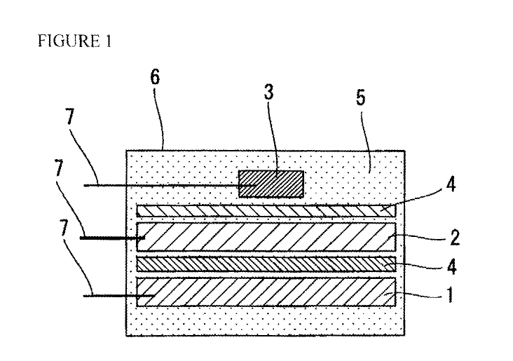

A test cell shown in FIG. 1 was formed using the negative electrode. In a glove box under an argon atmosphere, the test cell was foil led using the negative electrode as a working electrode 1 and a lithium metal for each of a counter electrode 2 and a reference electrode 3. An electrode tab 7 was attached to each of the working electrode 1, the counter electrode 2, and the reference electrode 3. The working electrode 1, the counter electrode 2, and the reference electrode 3 with polyethylene separators provided between the working electrode 1 and the counter electrode 2 and between the counter electrode 2 and the reference electrode 3 were sealed, together with a nonaqueous electrolytic solution 5, in a laminate container 6 composed of an aluminum laminate, thereby forming a test cell of Example 1.

The nonaqueous electrolytic solution 5 used was prepared by dissolving lithium hexafluorophosphate (LiPF₆) at a concentration of 1 mol/liter in a mixed solvent containing ethylene carbonate and ethylmethyl carbonate at a volume ratio of 3:7.

### Example 2

A test cell of Example 2 was formed by the same method as in Example 1 except that a zinc alloy was formed by mixing zinc particles and titanium particles to produce the composition TiZn₁₀ and was used as the first active material.

### Example 3

A test cell of Example 3 was formed by the same method as in Example 1 except that a zinc alloy was formed by mixing zinc particles and titanium particles to produce the composition TiZn₅ and was used as the first active material.

### Example 4

A test cell of Example 4 was formed by the same method as in Example 1 except that a zinc alloy was formed by mixing zinc particles and titanium particles to produce the composition TiZn₃ and was used as the first active material.

### Example 5

A test cell of Example 5 was formed by the same method as in Example 1 except that a zinc alloy was formed by mixing zinc particles and titanium particles to produce the composition TiZn₂ and was used as the first active material.

### Example 6

A test cell of Example 6 was formed by the same method as in Example 1 except that the first active material formed in Example 1 and the second active material were mixed at a mass ratio of 30:70.

### Example 7

A test cell of Example 7 was formed by the same method as in Example 1 except that the first active material formed in Example 1 and the second active material were mixed at a mass ratio of 40:60.

### Example 8

A test cell of Example 8 was formed by the same method as in Example 1 except that the first active material formed in Example 1 and the second active material were mixed at a mass ratio of 60:40.

### Example 9

A test cell of Example 9 was formed by the same method as in Example 1 except that the first active material formed in Example 1 and the second active material were mixed at a mass ratio of 70:30.

### Comparative Example 1

A test cell of Comparative Example 1 was formed by the same method as in Example 1 except that the zinc particles used as a raw material for forming the zinc alloy particles were used as the first active material for the negative electrode active material.

### Comparative Example 2

A test cell of Comparative Example 2 was formed by the same method as in Comparative Example 1 except that the first active material formed in Comparative Example 1 and the second active material were mixed at a mass ratio of 30:70.

### Comparative Example 3

A test cell of Comparative Example 3 was formed by the same method as in Comparative Example 1 except that the first active material formed in Comparative Example 1 and the second active material were mixed at a mass ratio of 40:60.

### Comparative Example 4

A test cell of Comparative Example 4 was formed by the same method as in Comparative Example 1 except that the first active material formed in Comparative Example 1 and the second active material were mixed at a mass ratio of 60:40.

### Comparative Example 5

A test cell of Comparative Example 5 was formed by the same method as in Comparative Example 1 except that the first active material formed in Comparative Example 1 and the second active material were mixed at a mass ratio of 70:30.

### [Charge/Discharge Test]

A charge/discharge test described below was performed using each of the test cells formed as described above in Examples 1 to 9 and Comparative Examples 1 to 5.

At room temperature, charge was performed with a constant current of 0.75 mA/cm² until the potential reached 0 V (vs. Li/Li⁺), then with a constant current of 0.25 mA/cm² until the potential reached 0 V (vs. Li/Li⁺), and further with a constant current of 0.1 mA/cm² until the potential reached 0 V (vs. Li/Li⁺). Then, discharge was performed with a constant current of 0.25 mA/cm² until the potential reached 1.0 V (vs. Li/Li⁺). For each of the test cells, the initial charge capacity, the initial discharge capacity, and the initial average action potential at the 1st cycle were measured.

Further, the above-described charge/discharge cycle was repeated to measure the discharge capacity of each of the test cells at the 10th cycle and 20th cycle.

The initial charge/discharge efficiency and capacity retention rate were determined according to the following expressions:

Initial charge/discharge efficiency (%)=(initial discharge capacity/initial charge capacity)×100

Capacity retention rate (%)=(discharge capacity at 10th cycle or 20th cycle/initial discharge capacity)×100

Table 1 shows the initial discharge capacity, the initial charge/discharge efficiency, the initial average action potential, and the capacity retention rates at the 10th cycle and 20th cycle.

TABLE 1

| | Negative electrode active material | | | Initial | | | | |
|---|---|---|---|---|---|---|---|---|
| | (ratio by mass) | | Mixing ratio | discharge | Initial | Initial average | Capacity | Capacity |
| | First active | Second active | of first active | capacity | charge/discharge | action potential | retention rate at | retention rate at |
| | material | material | material | (mAh/cm³) | efficiency | (V vs. Li/Li⁺) | 10th cycle | 20th cycle |
| Example 1 | TiZn₁₅ | Artificial graphite | 50% | 411.4 | 88.2% | 0.193 | 108% | 101% |
| Example 2 | TiZn₁₀ | Artificial graphite | 50% | 361.8 | 85.1% | 0.203 | 116% | 100% |
| Example 3 | TiZn₅ | Artificial graphite | 50% | 358.1 | 86.9% | 0.183 | 102% | 102% |
| Example 4 | TiZn₃ | Artificial graphite | 50% | 368.9 | 89.2% | 0.181 | 99% | 97% |
| Example 5 | TiZn₂ | Artificial graphite | 50% | 372.0 | 90.5% | 0.177 | 101% | 99% |
| Example 6 | TiZn₁₅ | Artificial graphite | 30% | 452.6 | 88.5% | 0.196 | 110% | 109% |
| Example 7 | TiZn₁₅ | Artificial graphite | 40% | 373.4 | 85.3% | 0.208 | 115% | 117% |
| Example 8 | TiZn₁₅ | Artificial graphite | 60% | 283.8 | 83.5% | 0.214 | 115% | 114% |
| Example 9 | TiZn₁₅ | Artificial graphite | 70% | 277.8 | 81.3% | 0.232 | 113% | 116% |
| Comparative | Zn | Artificial graphite | 50% | 482.2 | 70.1% | 0.211 | 57% | 46% |
| Example 1 | | | | | | | | |
| Comparative | Zn | Artificial graphite | 30% | 553.0 | 77.4% | 0.207 | 93% | 84% |
| Example 2 | | | | | | | | |
| Comparative | Zn | Artificial graphite | 40% | 570.8 | 73.6% | 0.216 | 89% | 76% |
| Example 3 | | | | | | | | |
| Comparative | Zn | Artificial graphite | 60% | 558.4 | 64.2% | 0.229 | 52% | 46% |
| Example 4 | | | | | | | | |
| Comparative | Zn | Artificial graphite | 70% | 557.5 | 59.2% | 0.244 | 30% | 18% |
| Example 5 | | | | | | | | |

Table 1 indicates that in Examples 1 to 9 using the zinc alloy particles according to the present invention, the initial charge/discharge efficiency and the capacity retention rates at the 10th cycle and 20th cycle are improved as compared with Comparative Examples 1 to using the zinc particles. This is considered to be due to the fact that expansion/contraction of zinc during charge and discharge is decreased by alloying with Ti, and thus size reduction of the zinc alloy particles and a decrease in current collecting property can be suppressed. Therefore, according to the present invention, the initial charge/discharge efficiency and cycling characteristics can be improved.

In Examples 1 to 3 and 5 to 9, the capacity retention rate at the 10th cycle is a value of 100% or more. This is considered to be due to the fact that cracks are formed in the negative electrode active material layer due to expansion/contraction of the zinc alloy particles after initial charge and discharge, thereby improving nonaqueous electrolyte permeability.

As shown in Table 1, the initial average action potential of each of Examples 1 to 9 is substantially the same as that of Comparative Example 1.

In addition, comparison of Examples 1 and 2 with Examples 3 to 5 indicates that x in TiZnₓ is more preferably in the range of 10≦x≦15.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a positive electrode containing a positive electrode active material;
a negative electrode containing a negative electrode active material; and
a nonaqueous electrolyte,
wherein a mixture containing a zinc-containing alloy represented by MZnₓ (wherein M is at least one metal that is not electrochemically alloyed with lithium) and a carbon material is used as the negative electrode active material.

2. The nonaqueous electrolyte secondary battery according to claim 1, wherein the metal M in MZnₓ is at least one selected from Ti, Cu, and Nb.

3. The nonaqueous electrolyte secondary battery according to claim 2, wherein the metal M in MZnₓ is Ti.

4. The nonaqueous electrolyte secondary battery according to claim 1, wherein x in MZnₓ is a value satisfying 2≦x≦15.

5. The nonaqueous electrolyte secondary battery according to claim 3, wherein x in MZnₓ is a value satisfying 2≦x≦15.

6. The nonaqueous electrolyte secondary battery according to claim 1, wherein x in MZnₓ is a value satisfying 10≦x≦15.

7. The nonaqueous electrolyte secondary battery according to claim 3, wherein x in MZnₓ is a value satisfying 10≦x≦15.

8. The nonaqueous electrolyte secondary battery according to claim 1, wherein the content of the zinc-containing alloy in the negative electrode active material is in the range of 5% to 80% by mass.

9. The nonaqueous electrolyte secondary battery according to claim 2, wherein the content of the zinc-containing alloy in the negative electrode active material is in the range of 5% to 80% by mass.

10. The nonaqueous electrolyte secondary battery according to claim 3, wherein the content of the zinc-containing alloy in the negative electrode active material is in the range of 5% to 80% by mass.

11. The nonaqueous electrolyte secondary battery according to claim 7, wherein the content of the zinc-containing alloy in the negative electrode active material is in the range of 5% to 80% by mass.

12. The nonaqueous electrolyte secondary battery according to claim 1, wherein the content of the zinc-containing alloy in the negative electrode active material is in the range of 30% to 70% by mass.

13. The nonaqueous electrolyte secondary battery according to claim 2, wherein the content of the zinc-containing alloy in the negative electrode active material is in the range of 30% to 70% by mass.

14. The nonaqueous electrolyte secondary battery according to claim 3, wherein the content of the zinc-containing alloy in the negative electrode active material is in the range of 30% to 70% by mass.

15. The nonaqueous electrolyte secondary battery according to claim 7, wherein the content of the zinc-containing alloy in the negative electrode active material is in the range of 30% to 70% by mass.

16. The nonaqueous electrolyte secondary battery according to claim 1, wherein the carbon material is graphite.

17. The nonaqueous electrolyte secondary battery according to claim 3, wherein the carbon material is graphite.

18. The nonaqueous electrolyte secondary battery according to claim 7, wherein the carbon material is graphite.

19. The nonaqueous electrolyte secondary battery according to claim 5, wherein the content of the zinc-containing alloy in the negative electrode active material is in the range of 5% to 80% by mass and wherein the carbon material is graphite.

20. The nonaqueous electrolyte secondary battery according to claim 15, wherein the carbon material is graphite.
